(19) United States
(12) Patent Application Publication
(10) Pub. No.: US 2007/0263020 A1
(43) Pub. Date: Nov. 15, 2007

(54) Ink jet manifold mechanism

(76) Inventors: Bruce Bradford, Fredrick, MD (US); Matthew Brown, Falls Church, VA (US); Edward Reagan, McLean, VA (US)

Correspondence Address: HERMAN J. HOHAUSER, 6212 BERLEE DRIVE, ALEXANDRIA, VA, 22312, US

(21) Appl. No.: 11/518,961

(22) Filed: Sep. 12, 2006

Related U.S. Application Data
(60) Provisional application No. 60/798,935, filed on May 10, 2006.

(51) Int. Cl. B41J 2/195

(52) U.S. Cl. 347/7

(57) ABSTRACT

A custom designed manifold mechanism, to be utilized in conjunction with an ink jet printer, having multiple ink reservoirs, an ink level display mechanism, a ink reservoir removal safety switch, an accurate ink level detection mechanism, ink cut-off valves, ink pressure sensors, and an electronic control system wherein ink reservoirs can be replaced without interrupting a print operation.

### FIELD OF THE INVENTION

This inventive system relates to ink jet printing. More specifically, the inventive system pertains to a system that uses ink supply cartridges in conjunction with a custom enclosure, and ink delivery control and ink level monitoring systems, for the purpose of delivering ink to an industrial printing apparatus. Control mechanisms incorporating ink level and ink pressure readings are used for the purpose of preventing system failures that often occur using traditional ink level monitoring methods.

### BACKGROUND OF THE INVENTION

Ink Jet printing is a common method of non-impact printing. An ink jet printer emits intermittent streams of ink droplets from tiny nozzles in response to received electrical signals. The present inventive system pertains to all types of ink jet printers.

When used in industrial applications, conventional ink jet printer ink delivery systems suffer from a variety of drawbacks and disadvantages. For example, it is difficult to accurately determine the level of ink in a reservoir modified for use in industrial applications using methods designed for home and office print systems. In addition, in the case of gravity-fed reservoirs, failure in the print system, whether it occurs in the print pressure regulator or in the ink jet print head, often leads to a free flowing ink situation wherein the ink in the reservoir simply runs freely out of the unit through the ink jets contained in the print mechanism. This can cause ink contamination of the print medium, which if unnoticed in an industrial printing operation, can become a costly problem in terms of the cost of the contaminated product, the cost of the lost ink and the cost of lost productivity resulting from an assembly line shut down to remedy a faulty print mechanism. In addition, reservoirs containing microprocessors must be protected so that they are removed in a specific powered state to avoid damage.

One method of determining the ink level of an reservoir is called “drop counting” When printing, an ink jet printer emits intermittent streams of ink, through a number of ink jet nozzles. Each intermittent pulse from a single nozzle consists of one “drop”. The drop counting technique measures ink usage by measuring how many times each ink jet in an ink jet print mechanism pulses. Knowing the average pulse size, one can roughly calculate how much ink has been drawn from the reservoir. However, over an operational period of time, this system has inherent flaws in that the stated quantity of ink in the reservoir often differs from the actual volume. This is because drop size may vary from pulse to pulse. Individual drop size variations might be seemingly minute, however when examined over several million pulses the accuracy of drop counting becomes subject to a high degree of error. Moreover, industrial printing applications require larger reservoirs than the home or office printers in which the drop counting system was invented for. This further compounds the inaccuracies involved in this type of ink level measurements.

Inductance measurement is another method of determining the volume of ink in a reservoir, however, this method only works for a percentage of the total volume. A pair of inductance coils are placed such that one coil is at the top of the reservoir and one at the bottom. An alternating current in the primary coil generates a changing magnetic field which in turn generates and alternating current in the secondary coil. A mechanism measures the secondary voltage normalized to the primary current and returns it as an indicator of ink level. The result depends on factors such as distance between the coils, electromagnetic properties of the ink, angle of the coils etc. At high and low ink levels this type of measurement is not very accurate, so it is most commonly used in conjunction with other methods such as drop counting. For example, HP uses both drop counting and inductance measurements to measure the ink level in their industrial ink reservoirs. They do this in three phases depending on the level of ink in the reservoir. They start with drop counting from 100% full to 51% full, then use inductance coil measurement from 50% full to 15% full then use drop counting for the remainder. Inductance measurements accurately work from, 50% of the total volume to 15%, but it yields inconclusive information pertaining to the ink level outside of this bound. The inductance measurement is a closed loop measurement operation designed to bridge the gap between two open loop and inaccurate drop counting operations.

This is notable for two reasons. First, many of the inks used in the ink jet printing process, especially custom inks and inks designed to have special properties, such as ink designed to be read by ultraviolet light, are reasonably expensive. Inaccurate ink measurements result in discarded ink cartridges containing useful ink or loss of productivity stemming from “dry printing”—print operations that perform without ink because the print controller erroneously believes the reservoir still contains usuable ink.

Second, in industrial printing applications there are many instances wherein the information needed for drop counting can not be harvested. For instance, some manufacturers do not make public their proprietary information needed to perform drop counting measurements. Additionally, many systems may be modified on site. Drop counting requires a known relationship between printer and corresponding reservoir. On site modifications that change this relationship of a print system, for example re-plumbing, produce useless and thusly inaccurate information.

Many reservoirs contain embedded microprocessors for the purpose of recording information pertaining to the type of ink, ink level, ink capacity, lot number, as well as custom fields that the end user may specify to his or her requirement, for example, custom reservoir identification numbers. These microprocessors require that the reservoirs be placed in a “stand-by” state prior to being removed from a powered operational state. Removal without placing the unit on stand-by may damage or destroy the microprocessor and thusly the information contained therein.

Prior art industrial manifold systems without cutoff mechanisms often draw air into their systems upon running out of ink. This requires that the ink delivery system be purged of all air after refilling the reservoir the installation of a new ink cartridge.

It is an object of the inventive system to solve the drawbacks of the aforementioned methods for measuring the ink level in reservoirs by using inductive current device, a mass flow device and a pressure sensor to accurately determine the volume of ink in a reservoir.

Another object of the inventive system is to provide a cut-off cut-off valve system to prevent the reservoir ink from freely flowing out of the system in the event of a damaged print component. A related object of this inventive system is to use the cut-off valve system to stop the print operation before air is drawn into the system during a low ink condition.

It is yet another object of the inventive system to provide a mechanism to restrict reservoirs containing embedded microprocessors from being removed from a manifold system without first being placed in a safe stand-by state.

Another object of the inventive system is to provide a mechanism to pressurize the reservoir for the purpose of creating a system that is not subject to the restrictions of a standard gravity fed system wherein the reservoir must be placed a specified minimum distance above the print mechanism.

### SUMMARY OF THE INVENTION

It is to be understood that both the foregoing and general description and the following detailed description are exemplary, but are not restrictive, of the inventive system. In accordance with the principles and objectives of the inventive system, the inventive system includes a custom enclosure and ink supply control mechanisms for the purpose of delivering regulated ink to a ink jet print system.

FIG. 9 is an isometric view of industrial manifold 100, consisting of safety switch 103, housing 150, gage 105 and reservoir 101-101c containing ink 120 is stored in reservoirs 101. Gage 105 consists of an array of LEDs wherein each vertical column corresponds to a specific reservoir for the purpose of providing a graphical representation of the amount (percentage) of ink 120. Housing 150 provides a stable mechanical enclosure for the purpose of protecting internal components from environmental contaminants such as dirt and water in addition to providing attachment features, not shown, to mate industrial manifold system to an external support member, also not shown.

Per FIG. 5, Industrial manifold 100 attaches to print system 200 and external controller 400 which consists of hardware and software controls. Print system 200 applies ink to print medium 300, which may be any medium capable of accepting ink 120 used in the ink-jet printing process. For the purpose of illustration, such mediums may include, but are not restricted to, paper, cardboard, ceramic tile, wood, concrete, plastic, metal, fabric and cloth.

It is an objective of the inventive system that industrial manifold 100 provides ink 120 to print system 200 such that reservoir 101 may be removed when empty and replaced while print system 200 maintains continuous operation. It is another object of the inventive system to create an accurate method of monitoring the level of ink 120 in reservoir 101 and displaying that information graphically It is yet another object of the inventive system to provide methods to ensure that air can not enter ink passages at any time. It is another object of the inventive system to provide a mechanism to place reservoir 101 in a safe state so that it may be removed from industrial manifold 100 without causing damage to electronics embedded in reservoir 101.

Several alternate embodiments of the inventive system propose, and are explained later in full detail, various methods of reaching stated objectives. For the purpose of monitoring the level of ink in reservoir 101, these methods include the use of mass flow sensor 109 to measure the quantity of ink 120 from reservoir 101 and the use of pressure sensor 104 to measure the weight of ink 120 in reservoir 101. For the purpose of creating a system which does not rely on gravity for ink transport, air pump 105 is used to pressurize reservoir 101.

Additionally, print system 200 consists of chief components: pressure switch 201, regulator 202 and print head 203. These components are integral in print system 200, and are depicted in one physical unit. Although these components are part of print system 200, they may be separated by distance and placed individual mechanical enclosures.

### DESCRIPTION OF FIGURES

FIG. 1 shows process diagram PL1 of preferred embodiment 1000 of the inventive system.

FIG. 2 shows process diagram PL2 of the inventive system in operation as it pertains to alternative embodiment 1001.

FIG. 3 highlights the process of sub-routine S1.

FIG. 4 shows subroutine S2.

FIG. 5 shows a graphical layout of the key components in preferred embodiment 1000 of the present inventive system.

FIG. 6 shows a graphical layout of the key components in alternate embodiment 1001 of the inventive system.

FIG. 7 shows a graphical layout of the key components in alternate embodiment 1002 of the inventive system.

FIG. 8 shows a graphical layout of the key components in alternative embodiment 1003 of the present inventive system.

FIG. 9 is an isometric view of industrial manifold 100.

FIG. 10 is an exploded view of industrial manifold 100.

### DETAILED DESCRIPTION OF THE INVENTION

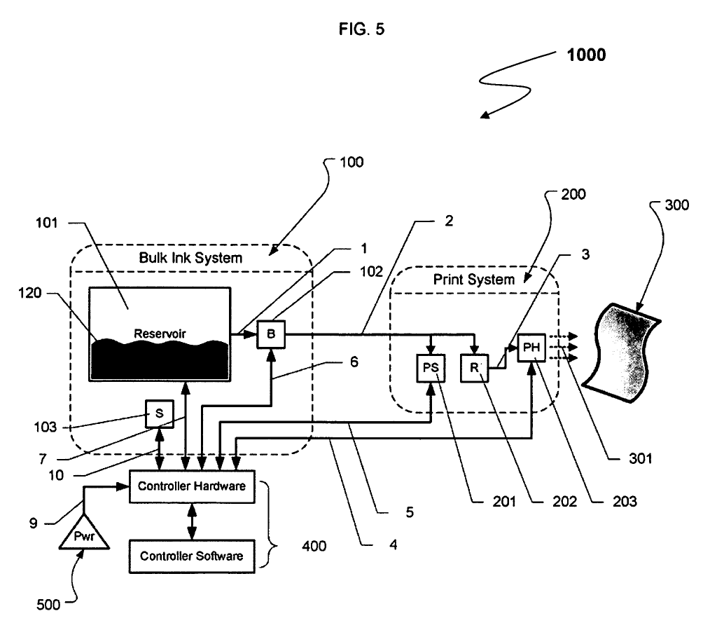

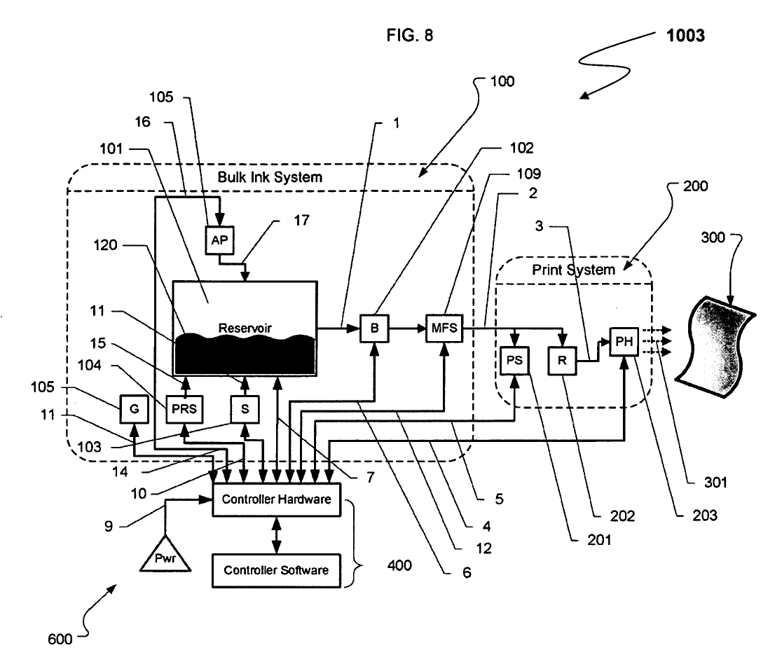

FIG. 5 shows preferred embodiment 1000 of the present inventive system, consisting of bulk ink system 100, print system 200, controller 400 and power supply 500. Bulk reservoir 101 contains ink 120. Industrial manifold 100 supplies ink 120 to print system 200 through ⅛″ ID tube 2, wherein ink 120 is applied to print medium 300 by print head 203. Note that ink 120 stream 301 is shown to illustrate the printing process. Ink 120 leaves reservoir 101 through ⅛″ ID tube 1 and passes through cut-off valve 102. Cut-off valve 102 is connected to controller 400 and is used for the purpose of stopping the flow of ink 120 to print system 200 when reservoir 101 becomes empty or in the event of a damaged print component in print system 200. It is important to note that this action prevents air from entering ink passages, for example, ⅛″ ID tubes 1 and 2. Controller 400 is a modified personal computer containing custom software written to govern both industrial manifold 100 and print system 200 for the purpose of printing on print medium 300. ⅛″ ID tube 2 connects bulk ink supply 100 to print system 200. Industrial manifold 100 and Print System 200 are not required to be located close together and may be separated by any reasonable distance. However, in preferred embodiment 1000, industrial manifold 100 delivers ink 120 via gravity and thusly must placed a minimum of 10 inches above print system 200. Note that this requirement is overcome, in FIG. 8 alternative embodiment 1003, by pressurizing reservoir 101. ⅛″ ID tube 2 delivers ink 120 to pressure switch 201 and regulator 202 by way of a common three port manifold, not shown. Pressure switch 201 connects to controller 400. When reservoir 101 contains enough ink 120 to allow for the proper operation of print system 200, and because of the relative difference in elevation between industrial manifold 100 and print system 200, pressure switch 201 and pressure regulator 202 are supplied ink 120 by ⅛″ ID tube 2 at a pressure greater than or equal to 10 inches of water. When this condition is met, pressure switch 201 is in an open circuit mode. When reservoir 101 no longer contains enough ink to support proper operation, pressure switch 201 is in a closed circuit mode. This information may be used by controller 400 to close cut-off valve 102 for the purpose of stopping the flow of ink 120 to print system 200 such that the print operation is interrupted is such a manner as to prevent air from entering tube 1, tube 2 or tube 3. Pressure regulator 202 delivers ink to print head 203 at less than atmospheric pressure for the purpose of preventing ink from freely flowing out of the ink jet mechanisms, not shown. Print head 203 communicates to controller 400 through cable 4. Regulator 202 works mechanically and does not require electrical input.

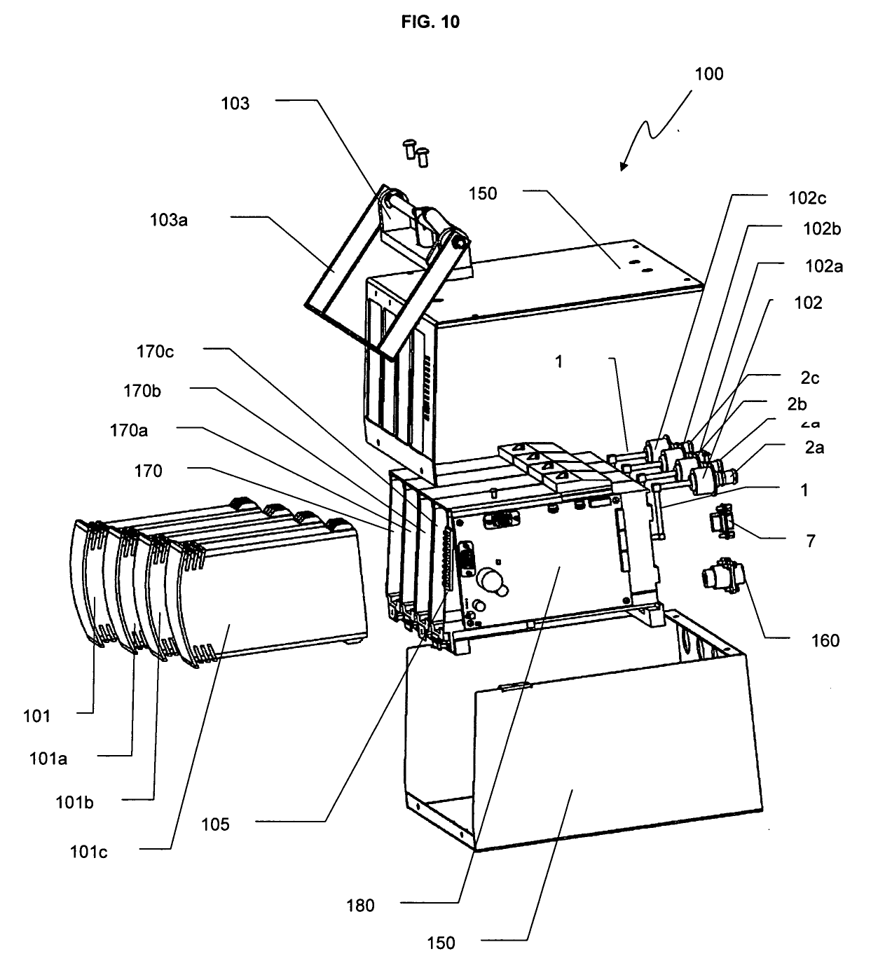

Reservoir 101 communicates with controller 400 via cable 7. Safety switch 103 consists of an u-shaped handle 103a and switch 103 as shown in FIG. 10. When u-shaped handle 103a is down, the circuit in switch 103 is closed. It is used, via controller 400, to stop the flow of ink from reservoir 101 in addition to placing reservoir 101 in a “stand-by” mode so that it can be disconnected from industrial manifold 100 without damaging the embedded electronics on reservoir 101. Safety switch 103 communicates with controller 400 by cable 10. Software driven actions derived from either the closed or open state of safety switch 103 are communicated to reservoir 101 by cable 7. Power is supplied to both industrial manifold 100 and print system 200 by power source 500.

In preferred embodiment 1000 the level of ink 120 in reservoir 101 is determined by a two methods, drop counting and inductance measurement, in a three phase approach that changes with the volume of ink 120. Phase one employs drop counting from the initial fill volume of reservoir 101 to approximately 51% of the volume.

In phase two a pair of inductance coils, not shown, embedded in reservoir 101 accurately measure the level of ink 120 from 50% to 15% of the volume. At this time, there is a correction made to the level of ink 120 level, as the volume information obtained from inductance measurements are more accurate than that of drop counting. As a result, a user looking at gage 105 may see a sudden change in ink level. Inductance measurements proceed until ink 120 volume drops below 15%.

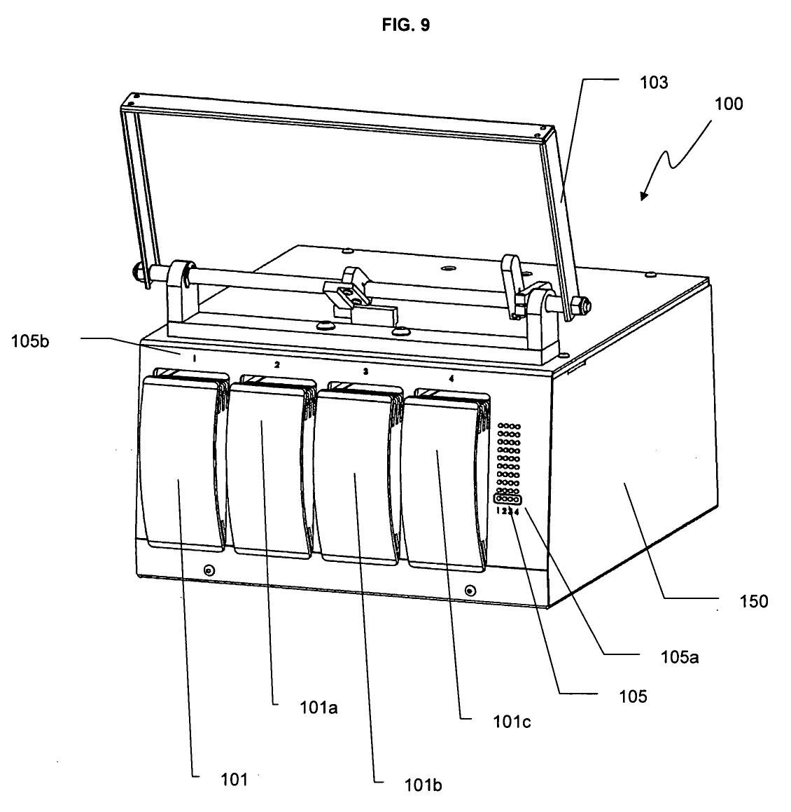

Phase three uses drop counting for the remaining ink 120 in reservoir 101. Note that drop counting is a open loop method and has no feedback, whereas inductance measurements consist of a closed loop procedure with feedback, and is therefore inherently more accurate. Phase two is used to bridge the gap between the two inaccurate drop counting measuring phases. Inductance measurements outside of the bound defined by 15% to 50% of the fill volume are not accurate. Ink 120 level information is displayed on gage 105, which may consist of a LED bar graph display on the inventive system per FIG. 9, or a of a software display on a computer screen receiving information from controller 400. In operation, a newly installed reservoir 101 contains a known volume of ink 120. Print system 200 applies ink 120 to print medium 300 by a series of ink jet pulses from print head 203. Each time print head 203 pulses, a known quantity of ink 120 is used and debited, via controller 400 from the known starting quantity of ink 120 in reservoir 101. When the level of ink 120 reaches approximately 51% of the initial fill volume, fluid volume measurements using the embedded inductance coils, not shown, imbedded in reservoir 120 begin.

FIG. 9 shows industrial manifold 100, which consists of housing 150, safety switch 103, gage 105 and four reservoirs 101-101c. It is to be understood that the inventive system may contain one to many reservoirs 101. Mechanical housing 150 shields internal components from environmental contaminants such as dirt, debris and water. Housing 150 mates to external support members, not shown, and is designed to be placed 10 inches above print system 200. Gage 105 consists of a LED array wherein four vertical columns represent the four reservoirs 101. The columns in gage 105 are labeled 1 through 4 corresponding to the numbers 150b above reservoirs 101. Individual LEDs in each column are illuminated to provide a visual representation of the amount of ink a corresponding reservoir 101. The row of LEDs 105a represents the bottom of gage 105's scale. When the only LED illuminated in a column is that in section 105a, reservoir 101 is empty. This condition may also be tied into a custom software operation in controller 400 for the purpose of issuing an audible alert, changing the condition on a stack light, changing an external display, or all of the above. Additionally, industrial manifold 100 may utilize a remote display, for example a computer monitor, which has a visual representation of gage 105 or a related visual output showing the amount of ink in individual reservoirs 101.

FIG. 10 is an exploded view of industrial manifold 100, consisting of housing 150, safety switch 103, stalls 170-170c, reservoirs 101-101c, tubes 1, cut-off valves 102-102c, male receptacles 2-2c and switch port 7, gage 105, circuit board 180 and communication port 160. Housing 150 consists of two sheet metal halves which provide support and protection of the internal components as well as providing a stable platform for external mounting members, not shown. Safety switch 103 is by controller 400 to place reservoirs 101 in a removable state when u-shaped handle 103a is lifted. Reservoirs 101-101c can not physically be removed when u-shaped handle 103a is resting in the lowered position as shown. When the u-shaped handle 103a is lifted, safety switch 103 is opened triggering a custom software operation in controller 400 to electrically isolate the embedded electronics in reservoirs 101. Removal of reservoirs without this action may damage or destroy the embedded electronics in reservoirs 101 and via-a-vi any stored information.

Reservoir 101c fit into stalls 170c respectively. Stall 170c connects an ink tube to reservoir 101c for the purpose of drawing ink, and an additional tube, not shown, which may be used to vent reservoir 101 to atmospheric pressure or to an external air pump for the purpose of pressurizing reservoir 101 for applications such as those explained in FIG. 8. Stall 170c also makes an electrical connection with the embedded electronics in reservoir 101c. Gage 105 is an LED array consisting of one vertical column of multiple LEDs per each reservoir 101-101c for the purpose of providing a graphical representation of the amount of ink in each individual reservoir. Circuit board 180 makes an electrical connection between external controller 400 and stalls 170-170c. Communication is made between industrial manifold 100 and controller 400 via a cable, not shown, that connects to communication port 160. Tube 1 takes ink from an interface in stall 170c, not shown, and connects it to cut-off valve 102. Cut-off valve 102 is used by controller 400 to stop the flow of ink in the event of a low fluid condition. This is noteworthy in that cut-off valve 102, when used with the overall control system, prevents air from entering the ink delivery system. If air were to enter the system, it would have to be stopped and all the air purged fluid delivery lines. Switch port 7 electrically connects safety switch 103 to controller 400. Male receptacles 2-2c protrude through housing 150 and mate with female connector(s), now shown, to deliver ink to print system 200.

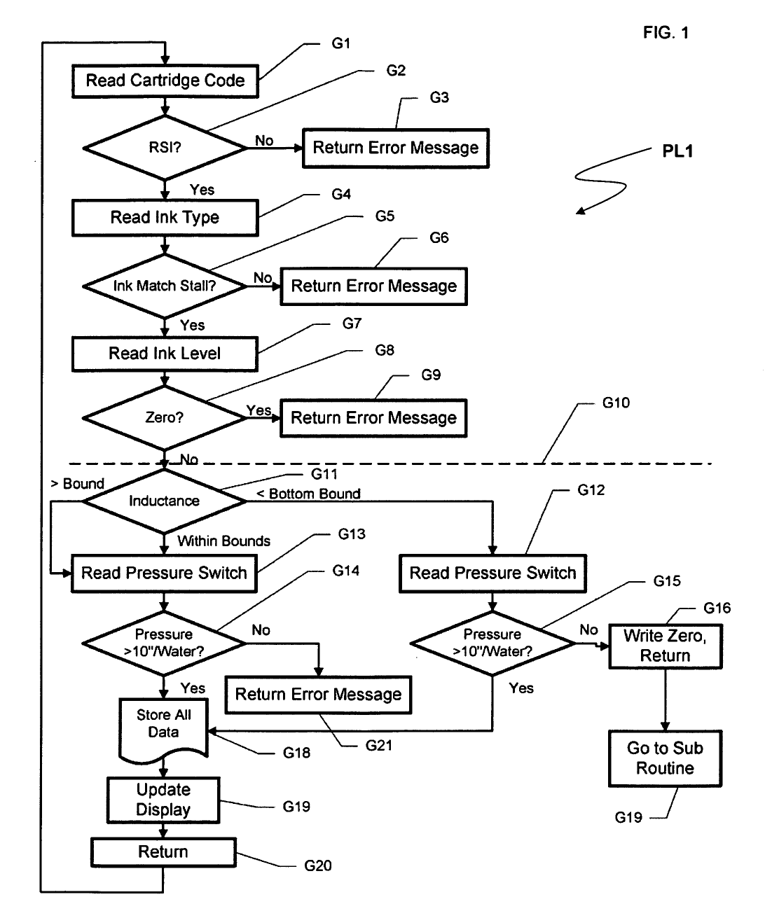

FIG. 1 describes the process flow of preferred embodiment 1000 of the inventive system. A process loop PL1 begins with step G1, wherein controller 400 reads a custom code stored on the embedded electronics in reservoir 101 for the purpose of determining whether the reservoir is compatible with industrial manifold 100. Reservoir 101 is deemed compatible if it physically fits into stall 170, shown in FIG. 10, if ink 120 is a type that is supported by industrial manifold 100, if the reservoir is from an approved vendor, and if the reservoir has sufficient ink 120 to support a printing process. It is important to note that a custom read-only code is written to the embedded electronics in reservoir 101 by the manufacturer of industrial manifold 100 (or an authorized supplier). This code is read in step G1 for the purpose of determining cartridge compatibility. If the code is rejected, an error message is returned per step G3. This and other error messages may be used to sound an alarm and warning light, stop industrial manifold 100, stop print system 200, perform a custom operation or all of the above. If the cartridge is compatible the process proceeds to step G4, where the ink type is read by controller 400 from information stored on the embedded electronics in reservoir 101.

Stall 170 is designed to accept one ink type only, therefore the ink type read from reservoir 101 must match the ink type controller 400 designates for stall 170. An error message is returned per step G6 if reservoir 101 contains an ink type unsupported by stall 170. In step G7, the ink level is read using by a two step decision process. First, reservoir 101 is checked to ensure that the embedded electronics have not been written “zero”, the command written when controller 400 determines reservoir 101 is out of ink 120. If a “zero” reading is present, than an error message is returned per step G9. If step G8 does not read “zero”, than an inductance reading is taken per step G11. In step G11, a decision is made between three possible states: one, the inductance reading is above the bounds of measurement, two, the inductance reading is within the bounds of measurement, or three the inductance reading is below the bounds of measurement. Whether the inductance reading in step G11 is above or within the bounds of measurement, both conditions proceed to step G13, however, an above bounds measurement is used to output one display condition, for example “full”, whereas an in-bounds condition is used to display another, for example, “half-full”.

When the reading from step G11 results in less than the bounds of measurement, the process proceeds to step G12. Pressure switch 201 is read in step G12. If it is above 10 inches of water, step G15 completes process loop PL1 and the process proceeds to step G18. If step G12 results in a reading less than 10 inches of water, “zero” is written to the embedded electronics in reservoir 101 and the operation proceeds to a sub routine S1 per step G19. In step G14, if pressure switch 201 reads less than 10 inches of water G21 returns an error message. This situation, where reservoir 101 has ample ink left but pressure switch 201 signals a low ink condition, results from a broken ink feed line in print system 200. In step G18, data read from the previous steps is written to the embedded electronics in reservoir 101 in addition to being recorded in controller 400, then step G19 updates the display of the ink level. Lastly, step G20 returns the process to step G1.

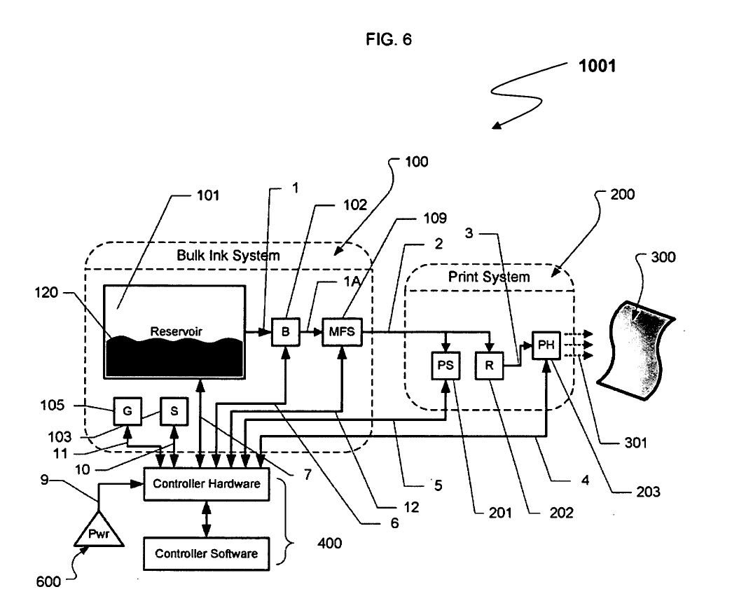

FIG. 6 shows alternate embodiment 1001 of the inventive system. In this embodiment, mass flow sensor 109 has been added as an alternative method of accurately determining the amount of ink 120 in reservoir 101. This method does not require input from inductance coils or drop counting as stated in FIG. 5, however, it may be used in conjunction with those and other methods to enhance the accuracy of the ink 120 level information. Mass flow sensor 109 is capable of monitoring ink 120 flow to a resolution of nanoliters per minute as ink 120 flows from industrial manifold 100 to print system 200.

Ink 120 leaves reservoir 101 by tube 1 which terminates in cut-off valve 102. Ink 120 is taken from cut-off valve 102 by tube 1A to mass flow sensor 109. Ink 120 leaves mass flow sensor 109 and industrial manifold 100 by tube 2, which feeds print system 200. Mass flow sensor 109 communicates with controller 400 the mass of ink 120, supplied by tube 1A, through mass flow sensor 109. Measurements are taken several times a second. Mass flow information, along with information regarding the initial fill volume of ink 120 in reservoir 101, is used to determine the level of ink 120 in reservoir 101 at all times during which there is a sufficient quantity of ink 120 in reservoir 101 to support a print operation. As ink 120 flows through mass flow sensor 109 it is debited from the known starting quantity of ink 120 in reservoir 101. Ink 120 level information is stored in the embedded electronics in reservoir 101 and displayed on gage 105 for the purpose of providing an operator with a visual representation of the level of ink 120 left in reservoir 101 in real time.

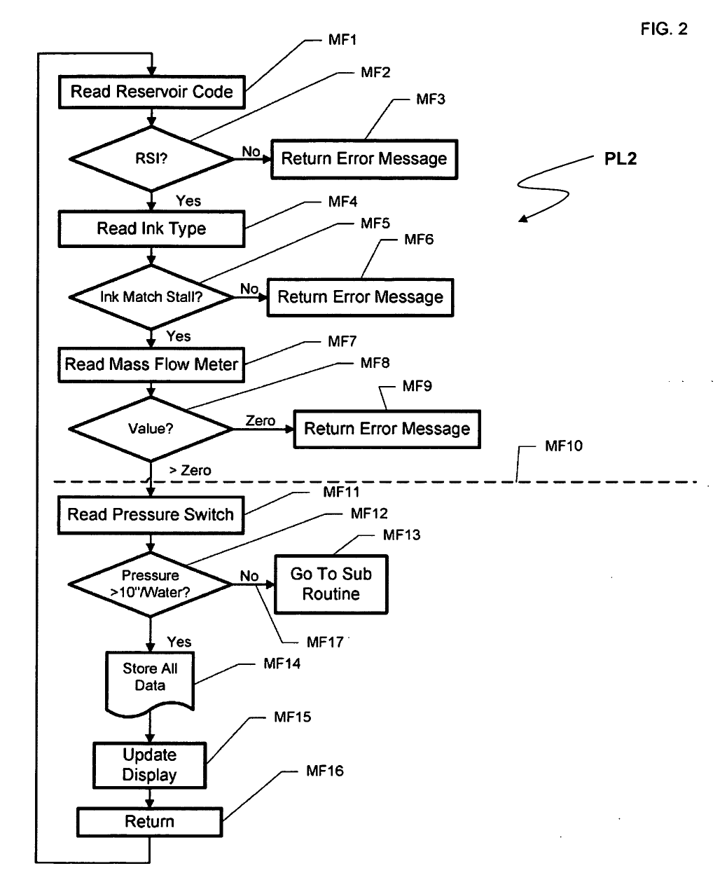

FIG. 2 describes the process flow of the inventive system in operation as it pertains to alternative embodiment 1001 as described in FIG. 6, wherein industrial manifold 100 includes mass flow sensor 109 for the purpose of accurately measuring the amount of ink 120 drawn from reservoir 101 at all times during which there is a sufficient quantity of ink 120 in reservoir 101 to support a print operation.

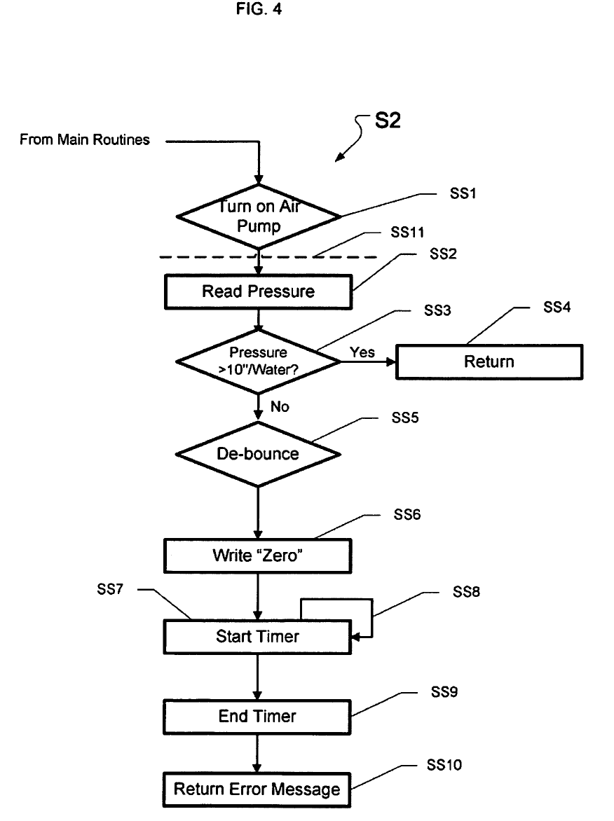

Process loop PL2 begins in step MF1, wherein controller 400 reads a custom code stored on the embedded electronics in reservoir 101 to verify that the reservoir is compatible with stall 170. It is important to note that a custom read-only code is written to the embedded electronics in reservoir 101, by the manufacturer of industrial manifold 100 or an authorized supplier, for the purpose of ensuring that only compatible reservoirs are accepted by industrial manifold 100. Step MF2, the custom code is checked by controller 400 for compatibility with stall 170. If the code is not approved, step MF3 returns an error message. Note that error messages may be used to sound an alarm and warning light, stop industrial manifold 100, stop print system 200, perform a custom operation or all of the above. If the code is approved, the process proceeds to step MF4, where the ink type is verified by matching ink information stored on the embedded electronics in reservoir 101, with the characteristics of the stall 170 reservoir 101 is inserted into. Bulk ink supply 100 is configured at the time of manufacturer such that individual stalls 170 stored in controller 400. In step MF6, if an unsupported ink type is inserted in stall 170 an error message is returned. If it is determined in step MF5 that the ink type is acceptable, than the process proceeds to step MF7 where mass flow sensor 109 flow rate information is recorded. Mass flow information, along with information regarding the initial fill volume of ink 120 in reservoir 101, that is the volume of a newly installed reservoir 101, is used to determine the level of ink 120 in reservoir 101 at all times during which there is a sufficient quantity of ink 120 in reservoir 101 to support a print operation. In step MF8 mass flow information is analyzed to determine the amount of ink being drawn from reservoir 101 and the information is stored. If this information reveals that the level of ink 120 in reservoir 101 is less than zero, step MF9 returns an error message. If step MF8 indicates that the level of ink 120 in reservoir 101 is greater than zero, the process proceeds to step MF11. Note that line MF10 indicates a time delay between steps MF8 and MF11 for the purpose of minimizing the chance of a faulty reading in step MF11 by allowing the reading in step MF11 to occur over a greater time distance than the prior steps. For example, step MF11 may take several seconds wherein if the reading is mostly positive the output will be yield step MF14, and if the output is mostly negative the output will yield step MF13. Alternatively, time delay MF10 may be replaced a sub-routine wherein step MF12 must return multiple negative answers MF17 in order to proceed to the sub-routine initiated by step MF13. In step MF11, controller 400 reads pressure switch 201 for the purpose of determining whether ink 120 in print system 200 is at a pressure greater than 10 inches of water. If it is not, step MF13 initiates sub-routine S1 as shown in FIG. 4. If ink 120 pressure in print system 200 is greater than 10 inches of water, step MF14 writes ink 120 level determined from step MF8, to the embedded electronics in reservoir 101. Then, step MF15 updates display 105, not shown, and finally, step MF16 completes Process loop PL2 and returns the program to the beginning.

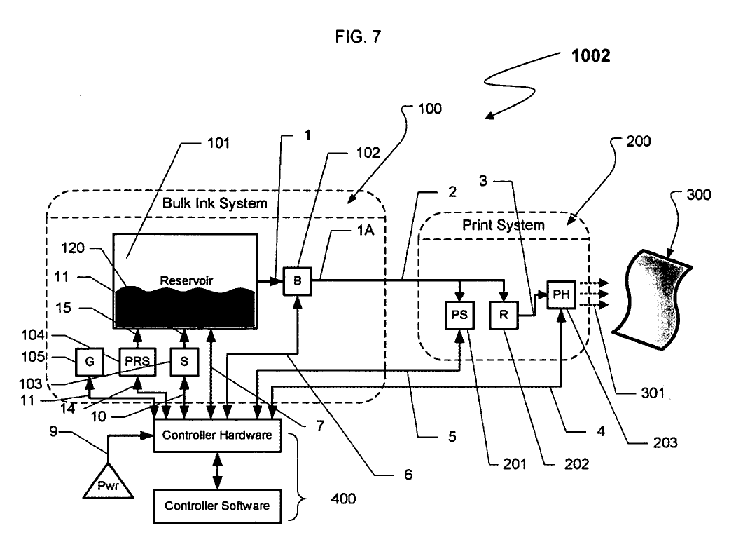

FIG. 7 shows alternate embodiment 1002 of the inventive system, wherein industrial manifold 100 includes pressure sensor 104 for the purpose of accurately measuring the volume of ink 120 in reservoir 101. The operation of print system 200 is identical to that in FIGS. 5 & 6. In this embodiment, the level of ink 120 in reservoir 101 is determined by measuring the weight of the ink in reservoir 101 using pressure switch 104. To do this it is requited that controller 400 knows the initial full weight of reservoir 101, the empty weight of reservoir 101 and the pressure on pressure sensor 104 at all times during which there is a sufficient quantity of ink 120 in reservoir 101 to support a print operation. Pressure sensor 104 feedback is used in conjunction with a custom algorithm to determine the weight of ink 120 in reservoir 101. This information is used to display the corresponding volume information on gate 105 for the purpose of providing an operator with a visual representation of the level of ink 120 left in reservoir 101 in real time.

FIG. 8 shows alternative embodiment 1003 of the present inventive system, wherein industrial manifold 100 includes air pump 105 for the purpose of pressurizing reservoir 101 such that it may be used without the constraints of a typical gravity fed system. For example, in gravity fed systems FIGS. 5,6 & 7, reservoir 101 in industrial manifold 100 must be located a minimum of 10 inches above print system 200. By pressurizing the air in reservoir 101 embodiment 1003 allows industrial manifold 100 to be placed below print system 200, and/or at a much greater distance from print system 200 than a traditional gravity fed system. The level of ink 120 in pressurized reservoir 101 may be measured using either of the aforementioned methods: inductance, mass flow sensor 109 or pressure sensor 104.

Air pump 105 receives electrical power from controller 400 for the purpose of regulating the pressure inside of reservoir 101. Pressure information is obtained from pressure switch 201 in print system 200. Air pump 105 activates when pressure switch 201 reads below 10 inches of water pressure in order to increase the pressure in reservoir 101. Air pump 105 continues to operate for a pre-determined period of time after pressure switch 201 indicates more than 10 inches of water pressure, this ensures continual operation of print system 200 as long as there is sufficient ink 120 in reservoir 101. If after a given period of time, pressure switch 201 does not indicate more than 10 inches of water pressure, the system returns an error message.

Alternate embodiment 1003 listed in FIG. 8 follows the process defined by FIG. 2, with the exception that step MF13 initiates the subroutine S2 shown in FIG. 4. Ink 120 level is monitored with mass flow meter 109 or pressure sensor 104, not shown. Using mass flow measurement, when mass flow meter 109 records a predetermined volume of ink 120 has been drawn out of reservoir 101, or alternatively, using pressure sensor 104 to indicate when a pre-determined weight of ink 120 is drawn out of reservoir 101, an error message is initiated by step MF9 indicating that reservoir 101 is empty. However, until that limit is reached, industrial manifold 100 operates normally until step MF12 indicates that there is less than 10 inches of water pressure, in which case a sub-routine begins per step MF13.

FIG. 4 shows subroutine S2, the process for pressurizing reservoir 101 such that it may supply ink from a location or position not possible by traditional gravity fed systems. For example, in this embodiment industrial manifold 100 may be placed below print system 200. In step SS1 air pump 105 activates to pressurize reservoir 101. Line SS11 represents a time delay in which air pump 105 operates before a pressure reading in pressure switch 201 is taken. In step SS3, controller 400 determines whether the pump operation in step SS1 supplied adequate pressure to supply the switch with more than 10 inches of water pressure. If the switch is above the 10 inch water pressure requirement, step SS4 returns the process to the beginning of FIG. 2. If it does not, the process proceeds to step SS5,a “de-bounce” element in which multiple readings are taken from reservoir 101, or, alternatively, a time delay is interjected into the process, to ensure that low pressure readings from pressure switch 201 are accurate and repeatable. This is important to prevent the permanent action in step SS6 from occurring when there is still useable ink in reservoir 101. This is especially important in environments where the unit is prone to contact by foreign bodies that could potentially jostle the unit in such a manner as to induce momentary false readings. Step SS6, writes “zero” ink remaining to the embedded electronics in reservoir 101. This command makes the reservoir permanently unusable by industrial manifold 100. Step SS6 write “zero” command also sends a signal to controller 400 for the purpose of alerting the operator that reservoir 101 is now empty.

Step SS8, a timer is started for a pre-determined period of time that corresponds to the maximum amount of time a small reservoir in the print cartridge, not shown, in print system 200 could support an ink intensive print operation. This allows an operator several minutes to replace reservoir 101 without stopping the print operation. When an operator replaces reservoir 101, the operation starts over from either G1 or MF1. If the operator does not do this before step SS9, the end of the timer operation, step SS10 returns an error message that may be used to stop print system 200 or conduct some other user defined operation.

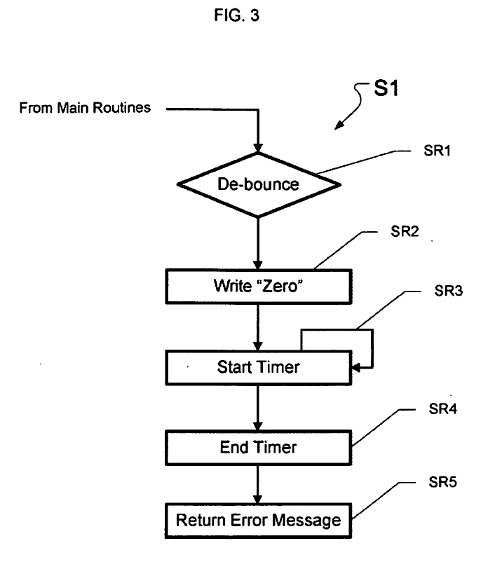

FIG. 3 describes the process of sub-routine S1. Sub-routine S1, by design allows a short period of time in which a newly empty reservoir 101 may be replaced without stopping the print operation. In FIG. 1, G19 and FIG. 2, MF13, reservoir 101 in bulk ink supply 100 is out of ink. However, a print cartridge, not shown, located in part of the ink jet mechanism, also not shown, in print system 200 contains a volume of ink sufficient such that printing can continue for a short period of time without drawing ink from reservoir 101. This is because the print cartridge, not shown, contains a small reservoir. In sub-routine S1, step SR1 is a “de-bounce” element in which multiple readings are taken from reservoir 101, or, alternatively, a time delay is interjected into the process, to ensure that low pressure readings from pressure switch 201 are accurate and repeatable. This is important to prevent the permanent action in step SR2 from occurring when there is still useable ink in reservoir 101. This is especially important in environments where the unit is prone to contact by foreign bodies that could potentially jostle the unit in such a manner as to induce momentary false readings. In step SR2, the command write “zero” writes zero ink remaining to the embedded electronics in reservoir 101. This command makes the reservoir permanently unusable by industrial manifold 100. Step SR2 write “zero” command also sends a signal to controller 400 for the purpose of alerting the operator that reservoir 101 is now empty.

Step SR3, a timer is started for a pre-determined period of time that corresponds to the maximum amount of time a small reservoir in the print cartridge, not shown, in print system 200 could support an ink intensive print operation. This allows an operator several minutes to replace reservoir 101 without stopping the print operation. When an operator replaces reservoir 101, the operation starts over from either G1 or MF1. If the operator does not do this before step SR4, the end of the timer operation, step SR5 returns an error message that may be used to stop print system 200 or conduct some other user defined operation.

1. In a printing system having reservoir means containing a pre-determined volume of ink connected to a print means a method of supplying ink to print media having the steps of; utilizing first means to control the ink flowing to said print media until said ink supply reaches a first predetermined amount, thereafter, utilizing separate and distinct second means for controlling ink flow to said print media until said ink supply reaches a second predetermined amount, and as a final step utilizing separate and distinct third means for controlling the ink flow to said print media until said ink supply reached a third predetermined amount.

2. The method of claim 1 wherein said first means employs an open loop method.

3. The method of claim 2 wherein said open loop method is ink drop counting means.

4. The method of claim 1 wherein said second means employs a closed loop procedure.

5. The method of claim 4 wherein said closed loop procedure is comprised of inductance coil means.

6. The method of claim 3 wherein closed loop procedure is comprised of inductance coil means.

7. The method of claim 1 wherein said third means employs an open loop method.

8. The method of claim 7 wherein said open loop method is ink drop counting means.

9. The method of claim 3 wherein said closed loop procedure is comprised of inductance coil means.

10. The method of claim 1 wherein said first means is operational until the volume of said reservoir means is less then 51% of the starting volume.

11. The method of claim 10 wherein said second means is operation when the volume of said reservoir means is between 15% and 51% of the start volume.

12. The method of claim 11 wherein said third means is operational when the volume in said reservoir means is less than 15% of the start volume.
